(19) United States
(12) Patent Application Publication
(10) Pub. No.: US 2024/0276620 A1
(43) Pub. Date: Aug. 15, 2024

(54) LIGHT ASSEMBLY FOR POWERING LIGHTING FUNCTIONS WITH DIFFERENT POWER REQUIREMENTS

(71) Applicant: VALEO VISION, Bobigny (FR)

(72) Inventors: Rujiu OU, Foshan (CN); Jintao LIANG, Foshan (CN)

(73) Assignee: VALEO VISION, Bobigny (FR)

(21) Appl. No.: 18/258,669

(22) PCT Filed: Dec. 21, 2020
(86) PCT No.: PCT/CN2020/138075

§ 371 Date: Jun. 21, 2023

(51) Int. Cl. H05B 47/16; B60Q 1/14; H05B 45/325; H05B 45/48; H05B 47/105; H05B 47/155

(52) U.S. Cl. CPC H05B 47/16; H05B 45/325; H05B 45/48; H05B 47/105; H05B 47/155; B60Q 1/1415

(57) ABSTRACT

A light assembly includes a first lighting module configured to perform a first lighting function, a second lighting module configured to perform a second lighting function, a driver connected in series with the lighting modules. Each lighting module is controlled via a switching unit by a controller. The driver is configured to generate a constant output power and the controller is configured to vary the power provided to the first lighting module or to the second lighting module by controlling the first switching unit or the second switching unit using Pulse Width Modulation (PWM).

The present invention concerns the technical field of lighting. It concerns in particular, while not exclusively, a light assembly comprising lighting modules and a driver for powering the lighting modules.

It is advantageous in the case where several lighting functions are to be performed by a single light assembly and in the case where the lighting functions have different power requirements.

The Japanese patent application JP6257485 discloses an assembly comprising a LED device that can independently turn on and off an arbitrary number of LEDs among a plurality of LEDs connected in series.

However, in the prior art, all the LEDs participate to the same lighting function and therefore their power requirements are easier to control compared to an assembly performing several lighting functions.

There is therefore a need for a light assembly arranged for powering several lighting functions while taking into account their respective power requirements.

The present invention improves the situation.

To this end, a first aspect of the invention concerns a light assembly comprising:
a first lighting module configured to perform a first lighting function;
a second lighting module configured to perform a second lighting function;
a driver connected in series with the first lighting module and the second lighting module;
a first switching unit connected in parallel to the first lighting module;
a second switching unit connected in parallel to the second lighting module;
a controller configured to control the first switching unit and the second switching unit.

The driver is configured to generate a constant output power and the controller is configured to vary the power provided to the first lighting module or to the second lighting module by controlling the first switching unit or the second switching unit using Pulse Width Modulation, PWM.

Therefore, the switching unit can be advantageously used for activating/deactivating their associated lighting functions, and for adapting the power provided to the lighting modules. This allows performing several lighting functions with different power requirements with a single driver and a fixed output power.

According to some embodiments, the first lighting function may be a high beam function and the second lighting function may be a low beam function, and the controller may be configured to control both the first switching unit and the second switching unit using PWM.

The flexibility of the light assembly is therefore improved and this allows performing lighting functions that are complementary.

According to some embodiments, the assembly may further comprise a third lighting module configured to perform a third lighting function and a third switching unit connected in parallel to the third lighting function, the third lighting module may be in low side position compared to the first and second lighting modules, and the controller may be further configured to control the third switching unit using PWM to vary the power provided to the third lighting module.

This allows performing at least three lighting functions that potentially have different power requirements.

In complement, the third lighting module may be configured to perform a position lighting function, a daytime lighting function or to perform both a position lighting function and a daytime lighting function.

These functions allow to make the vehicle visible to other vehicles on the road.

Alternatively or in complement, the assembly may further comprise a fourth lighting module configured to perform a fourth lighting function, and a fourth switching unit connected in parallel to the fourth lighting module, the fourth lighting module may be in low side position compared to the first, second and third lighting modules, and the controller may be further configured to control the fourth switching unit using PWM to vary the power provided to the fourth lighting module.

Therefore, this allows performing at least four lighting functions that potentially have different power requirements.

In complement, the third lighting function may be a daytime lighting function and the fourth lighting function may be a position lighting function.

Indeed, daytime lighting function and position lighting function may have different requirements in terms of power to be provided to their lighting modules. The power value used for the position lighting function may be lower than the one for daytime lighting function, to avoid glaring other drivers on the road. Also, the power values can be varied depending on external conditions such as external brightness.
According to some embodiments, the switching units may be controlled by the controller via respective control circuits.
This allows to adapt the signals issued by the controller to the switching units, for example to their respective technologies (PMOS, NMOS, etc).
In complement, at least one of the switching units may be controlled by the controller via an attenuation circuit, and the attenuation circuit may be arranged to decrease a slope rate of a voltage controlling the at least one switching unit.

This allows protecting the light assembly against excessive surge currents, when the lighting function corresponding to the low side switching unit is turned off.

In complement, the switching unit located in low side position compared to the other switching units may be controlled by the controller via the attenuation circuit.

This allows to protect the light assembly against excessive surge currents with a simple attenuation circuit. Indeed, in low side position, the protection circuit can easily be connected to the ground.
Still in complement, the attenuation circuit may comprise an attenuation capacitor and an attenuation resistor.
The attenuation capacitor allows to efficiently decrease the slope rate of the voltage controlling the low side switching unit, at low cost.
Still in complement, the low side switching unit may be an NMOS, the attenuation capacitor may be connected between a drain of the NMOS and a gate of the NMOS, and the attenuation resistor may be connected to the gate of the NMOS.
This allows to control the switching unit in PWM, while protecting the light assembly against excessive surge currents.
According to some embodiments, the assembly may further comprise an absorber circuit in parallel to the lighting modules, the controller may be configured to turn on the absorber circuit before turning off one of the switching units to deactivate one of the lighting functions.
In complement, the absorber circuit may comprise an absorber resistor and an absorber switching unit and the absorber circuit may be turned on by closing the absorber switching unit.
This allows to protect the light assembly against excessive surge currents, when one of the lighting functions is turned off.
Alternatively or in complement, the assembly may be configured to perform the following sequence to deactivate one of the lighting functions:
   turn off the driver;
   turn on the absorber circuit;
   turn off the switching unit in parallel to the lighting function to be deactivated.

Other features and advantages of the invention are made explicit from the description detailed hereafter, and from the attached drawings, on which:

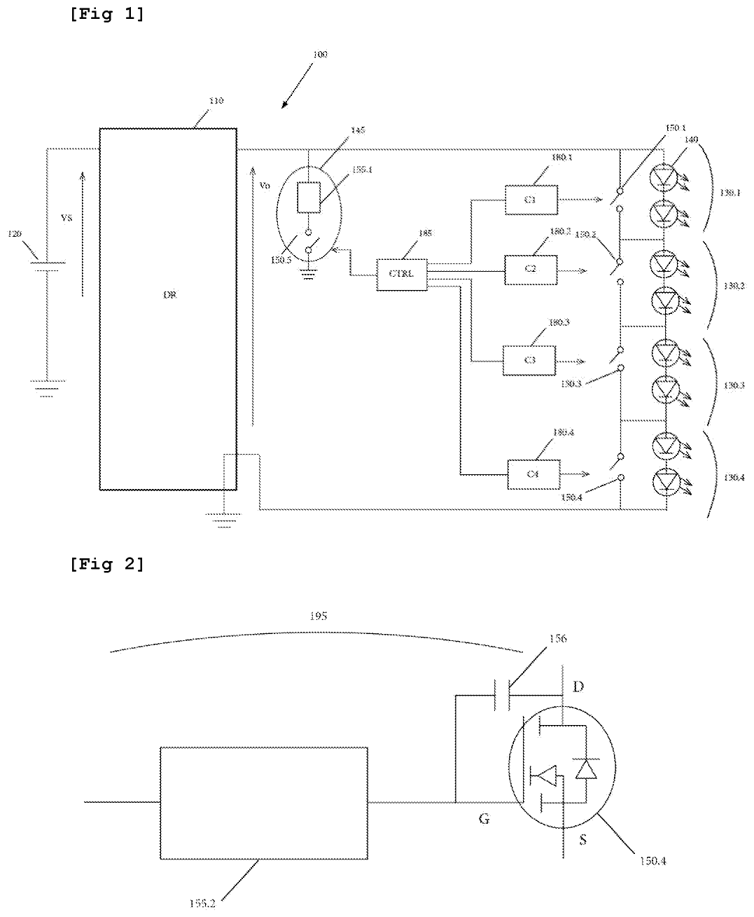

FIG. 1 shows a light assembly according to some embodiments of the invention;

FIG. 2 shows a control circuit of a switching unit, according to some embodiments of the invention.

FIG. 1 illustrates a light assembly 100 according to some embodiments of the invention.

The light assembly comprises a power source 120 and a driver 110.

The voltage source 120 may be a DC voltage source and the driver 110 may be a DC/DC driver. Alternatively, the voltage source 120 may be an AC voltage source and the driver 110 may be an AC/DC driver.

The voltage source 120 is configured to apply a source voltage Vs to the driver 110 and the driver 110 is configured to output an output voltage Vo.

The light assembly 100 according to the invention further comprises at least a first lighting module 130.1 arranged to perform a first lighting function and a second lighting module 130.2 arranged to perform a second lighting function. The first and second lighting modules 130.1 and 130.2 are connected in series with the driver 110.

According to the example given referring the FIG. 1, the light assembly 100 further comprises a third lighting module 130.3 arranged to perform a third lighting function and a fourth lighting module 130.4 arranged to perform a fourth lighting function. No restriction is attached to the number of lighting functions that are performed by the light assembly 100: it can be any number greater than or equal to two.

In what follows, and for illustrative purposes only:
the first lighting function is a High Beam, HB, function;
the second lighting function is a Low Beam, LB, function;
the third function is a Daytime Running Light, DRL;
the fourth function is a Position Lighting, PL, function.

For example, the light assembly 100 may comprise at least the LB and HB functions. The LB and HB functions are complementary functions and the HB function is additional to the LB function: this means that the HB function should only be activated while the LB is turned on. However, the LB function can be turned on while the HB function is turned off. However, in the topology according to the invention, the HB function can technically be activated alone, as it will be understood from the description below.

It is however to be understood that the invention applies to any combination of at least two lighting functions. Also, the light assembly 100 may perform lighting function(s) other than HB, LB, PL and DRL, such as the Turn Indicator (TI) function or fog lighting function.

The first, second, third and fourth lighting modules 130 may be integrated in a headlamp. It is to be noted that the third lighting module 130.3 may be able to perform both the DRL and PL functions. In that case, the fourth lighting module 130.4 can be removed.

The first lighting module 130.1 may comprise a first series of lighting units 140, the second lighting module 130.2 may comprise a second series of lighting units 140, the third lighting module 130.3 may comprise a third series of lighting units 140 and the fourth lighting module 130.4 may comprise a fourth series of lighting units 140.

The lighting units 140 can be any technology able to emit light when power is provided to it. In what follows, the example of lighting units being diodes such as LEDs is considered, for illustrative purposes only. The wording «LED» is therefore used to replace «lighting unit» in what follows, without departing from the fact that the lighting unit can encompass other technologies than LED.

No restriction is attached to the number of LEDs 140 per function. In the example shown on FIG. 1, each of the functions is implemented by respective series of two LEDs 140. However, according to the invention, the lighting functions can be implemented by any numbers n1, n2, n3 and n4 of LEDs 140, n1, n2, n3 and n4 being integers equal to or greater than 1.

So as to selectively activate/deactivate the lighting functions, the light assembly 100 may further comprise:
a first switching unit 150.1 for activating/deactivating the HB function;
a second switching unit 150.2. for activating/deactivating the LB function;
a third switching unit 150.3 for activating/deactivating the DRL function;
a fourth switching unit 150.4 for activating/deactivating the PL function.

Each switching unit is connected in parallel to the lighting module it controls.

No restriction is attached to the technologies used for the switching units, which can for example be any transistor configured to perform a switching function. For example, the switching units may be N-MOS. Alternatively, the switching units may be P-MOS.

The first switching unit 150.1 may be controlled by a controller 185 via a first control circuit 180.1, the second switching unit 150.2 may be controlled by the controller 185 via a second control circuit 180.2, the third switching unit 150.3 may be controlled by the controller 185 via a third control circuit 180.3 and the fourth switching unit 150.4 may be controlled by a controller 185 via a fourth control circuit 180.4.

Each control circuit 180 may be able to adapt control signals transmitted by the controller 185 to the respective switching unit 150 it controls.

The control circuits 180 are optional in that the controller may directly control the switching units 150, according to some embodiments of the invention.

The controller 185 is in charge of issuing control signals based on commands received for example from an external control unit.

No restriction is attached to the technology used for the controller 185, which may be a micro-controller MCU for example.

According to the invention, the lighting functions are powered using Pulse Width Modulation, PWM, on the switching units 150. This allows to have a constant output power, such as a constant output voltage Vo of the driver 110 and however to be able to vary the power provided to the lighting functions based on different duty cycles. The duty cycles applied to the switching units 150 may vary depending on the respective lighting functions they control.

For example, the duty cycle applied to the first switching unit 150.1 controlling the HB function is generally smaller than the duty cycle applied to the fourth switching unit 150.4 controlling the PL function.

Also, a first power value can be applied to the third lighting module 130.3 for the DRL function while a second power value, different from the first power value, may be applied for the fourth lighting module 130.4 for the PL function. The first power value may be less than the second power value, which allows to avoid glaring other drivers at night time, and to ensure that the vehicle is visible at day time. This improves the security associated with the lighting functions and also optimizes the power consumption of the light assembly 100.

The principles of PWM are well known and are not further described.

It is to be noted that several functions can be activated at the same time. For example, LB, HB and PL can be activated during a common period, with first, second and fourth switching units being controlled by PWM control signal issued from the controller 185.

The duty cycles and the timing of the PWM control signals are determined by the controller 185, which is in charge of powering and synchronizing the lighting functions.

It is to be noted that many modern MCUs integrate PWM controllers exposed to external pins.

According to the invention, some of the functions can be powered directly by the output power of the driver, such as the output voltage Vo, without performing PWM on their associated switching unit.

The duty cycle associated with each function may also be varied depending on external conditions. For example, the duty cycle applied to the third switching unit associated with the DRL function may be varied depending on external conditions such as brightness.

Therefore, switching units in parallel to respective lighting modules allows performing several lighting functions with LEDs in series, whereas the prior art only allows adding or removing LEDs to a single lighting function.

When some of the lighting modules are turned off, it can generate an excessive surge current in the circuit, and therefore on the other lighting modules that are still activated. This may for example happen when the first lighting module 130.1 associated with the HB function is turned off, while the PL function and the LB function remain activated.

To avoid this, the light assembly 100 may further comprise an absorber circuit 145 that is arranged to mitigate the surge current when a lighting module is turned off.

The absorber circuit 145 may comprise an absorber resistor 155.1 and an absorber switching unit 150.5. In order to turn off a lighting module while effectively absorbing the resulting surge current, the following sequence can be performed by the light assembly 100:
turn off the driver 110;
turning on the absorber circuit 145, for example by closing the fifth switch 150.5;
turn on at least one of the first, second, third and fourth switching units 150 depending on the lighting functions to be deactivated.

This allows protecting the light assembly 100 against excessive surge currents.

Another solution for preventing surge currents, complementary or alternative to the absorber circuit 145 shown on FIG. 1, is illustrated referring to FIG. 2. It may consist in adding an attenuation circuit 195 in the control unit 180 of one of the lighting modules. For example, the attenuation circuit 195 may be added in the control unit 180 of the lighting module in low side position compared to other lighting modules of light assembly 100.

In what follows, we consider that the attenuation circuit 195 is added in the fourth control unit 180.4 controlling the fourth switching unit 150.4, because the fourth lighting module 130.4 is in low side position compared to the other lighting modules 130.1, 130.2 and 130.3. However, the attenuation circuit 195 may be added to any of the control units 180.1, 180.2, 180.3 and 180.4 according to the invention. It may also be added to several of the control units, such as the control units corresponding to the lighting modules in low side position. When the light assembly only comprises the first lighting module 130.1 and the second lighting module 130.2, the control unit 180.2 may comprise the attenuation circuit 195.

The attenuation circuit 195 is arranged for decreasing a slope rate of a voltage controlling the switching unit 150.4. To this end, the attenuation circuit 195 may comprise an attenuation capacitor 156 and an attenuation resistor 155.2.

As shown on FIG. 2, the fourth switching unit 150.4 may be an NMOS, the attenuation capacitor 156 may be arranged between the drain and the gate of the fourth switching unit 150.4 and the attenuation resistor 155.2 is connected to the gate. The source is connected to the ground whereas the drain is connected to the third switching unit 150.3. This architecture is called a miller circuit and it allows preventing excessive surge current when the PL function is turned off, by decreasing the slope rate of the voltage between the gate and the source of the fourth switching unit 150.4. In addition, the attenuation circuit 195 requires less MCU sources (PIN, timer), when it works in PWM mode, compared to the embodiment with the absorber circuit 145. Indeed, if there is no attenuation circuit 195, the controller 185 needs to provide PWM signals to the control units 180, to the absorber circuit 145 and to the driver 110 synchronously. If the attenuation circuit 195 is used, the controller 185 only needs to provide PWM signal to one of the switching units, such as the low side switching unit 180.4 and there is no need to control the driver 110 and the absorber circuit 145.

Alternatively, the fourth switching unit 150.4 may be a PMOS: in that case, the attenuation circuit 195 is different from the one illustrated on FIG. 2, with the capacitor 156 connected between the gate and the drain of the PMOS.

Therefore, as explained above, the attenuation circuit 195 and the absorber circuit 145 both contribute to solve the inrush current issue.

In addition, in the embodiment shown on FIG. 1, the lighting modules 130.1, 130.2 and 130.3 may be dedicated to the HB, LB and DRL functions respectively and attenuation circuits are not used for these lighting modules, so that they may share the same absorber circuit 145 to solve the inrush current issue.

As described above, the attenuation circuit 195 is preferably in low side position, as it allows a more simple and low cost attenuation circuit. However, the attenuation circuit 195 may also be used to control another switching unit than the low side switching unit.

However, when the attenuation circuit 195 is not in lowest position, the attenuation circuit 195 is necessarily more complex, to provide Vgs that does not refer to the ground. For example, when the switching unit controlled via the attenuation circuit is a NMOS, an additional circuit comprising an isolated power supplier can be used to provide a voltage VCC. When the switching unit controlled via the attenuation circuit is a PMOS, an additional circuit comprising an isolated power supplier can be used to provide a voltage −VCC.

In any of the embodiments described above, the driver 110 may encompass any technology that is able to convert an input voltage into an output voltage different from the input voltage. The source and output voltages Vs and Vo may differ by their type (DC or AC) and/or by their values (two DC voltage having different values). The drivers can for example be electronic circuitries, such as Single Ended Primary Inductor Converters, SEPICs. However, no restriction is attached to the circuitry used as the drivers 110 which can encompass other examples, such as buck converters, boost converters and/or buck-boost converters.

The present invention is not limited to the embodiments described above as examples: it extends to other alternatives.

1. A light assembly comprising:
a first lighting module configured to perform a first lighting function;
a second lighting module configured to perform a second lighting function;
a driver connected in series with the first lighting module and the second lighting module;
a first switching unit connected in parallel to the first lighting module;
a second switching unit connected in parallel to the second lighting module;
a controller configured to control the first switching unit and the second switching unit;
wherein:
the driver is configured to generate a constant output power and the controller is configured to vary the power provided to the first lighting module or to the second lighting module by controlling the first switching unit or the second switching unit using Pulse Width Modulation, PWM.

2. The assembly according to claim 1, wherein the first lighting function is a high beam function and the second lighting function is a low beam function and wherein the controller is configured to control both the first switching unit and the second switching unit using PWM.

3. The assembly according to claim 1, further comprising a third lighting module configured to perform a third lighting function and a third switching unit connected in parallel to the third lighting function, wherein the third lighting module is in low side position compared to the first and second lighting modules, and wherein the controller is further configured to control the third switching unit using PWM to vary the power provided to the third lighting module.

4. The assembly according to claim 3, wherein the third lighting module is configured to perform a position lighting function, a daytime lighting function or to perform both a position lighting function and a daytime lighting function.

5. The assembly according to claim 3, further comprising a fourth lighting module configured to perform a fourth lighting function, a fourth switching unit connected in parallel to the fourth lighting module, wherein the fourth lighting module is in low side position compared to the first, second and third lighting modules, and wherein the controller is further configured to control the fourth switching unit using PWM to vary the voltage applied to the fourth lighting module.

6. The assembly according to claim 5, wherein the third lighting function is a daytime lighting function and the fourth lighting function is a position lighting function.

7. The assembly according to claim 1, wherein the switching units are controlled by the controller via respective control circuits.

8. The assembly according to claim 7, wherein at least one of the switching units is controlled by the controller via an attenuation circuit, wherein the attenuation circuit is arranged to decrease a slope rate of a voltage controlling the at least one switching unit.

9. The assembly according to claim 8, wherein the switching unit in low side position compared to the other switching units is controlled by the controller via the attenuation circuit.

10. The assembly according to claim 8, wherein the attenuation circuit comprises an attenuation capacitor and an attenuation resistor.

11. The assembly according to claim 9, wherein the low side switching unit is an NMOS, wherein the attenuation capacitor is connected between a drain of the NMOS and a gate of the NMOS, and wherein the attenuation resistor is connected to the gate of the NMOS.

12. The assembly according to claim 1, further comprising an absorber circuit in parallel to the lighting modules, wherein the controller is configured to turn on the absorber circuit before turning off one of the switching units to deactivate one of the lighting functions.

13. The assembly according to claim 11, wherein the absorber circuit comprises an absorber resistor and an absorber switching unit and wherein the absorber circuit is turned on by closing the absorber switching unit.

14. The assembly according to claim 11, wherein the assembly is configured to perform the following sequence to deactivate one of the lighting functions:
turn off the driver;
turn on the absorber circuit;
turn off the switching unit in parallel to the lighting function to be deactivated.

15. The assembly according to claim 2, further comprising a third lighting module configured to perform a third lighting function and a third switching unit connected in parallel to the third lighting function, wherein the third lighting module is in low side position compared to the first and second lighting modules, and wherein the controller is further configured to control the third switching unit using PWM to vary the power provided to the third lighting module.

16. The assembly according to claim 4, further comprising a fourth lighting module configured to perform a fourth lighting function, a fourth switching unit connected in parallel to the fourth lighting module, wherein the fourth lighting module is in low side position compared to the first, second and third lighting modules, and wherein the controller is further configured to control the fourth switching unit using PWM to vary the voltage applied to the fourth lighting module.

17. The assembly according to claim 2, wherein the switching units are controlled by the controller via respective control circuits.

18. The assembly according to claim 2, further comprising an absorber circuit in parallel to the lighting modules, wherein the controller is configured to turn on the absorber circuit before turning off one of the switching units to deactivate one of the lighting functions.

19. The assembly according to claim 12, wherein the assembly is configured to perform the following sequence to deactivate one of the lighting functions:
turn off the driver;
turn on the absorber circuit;
turn off the switching unit in parallel to the lighting function to be deactivated.

20. The assembly according to claim 3, wherein the switching units are controlled by the controller via respective control circuits.
